(19) United States
(12) Patent Application Publication
(10) Pub. No.: US 2026/0153601 A1
(43) Pub. Date: Jun. 4, 2026

(54) CIRCUIT BOARD STRUCTURE AND LIDAR

(71) Applicant: SUTENG INNOVATION TECHNOLOGY CO., LTD., Shenzhen (CN)

(72) Inventors: Chencong WANG, Shenzhen (CN); Xin ZHAO, Shenzhen (CN); Zhen HE, Shenzhen (CN); Fenglian XU, Shenzhen (CN); Congcong ZHU, Shenzhen (CN); Youxue LEI, Shenzhen (CN)

(73) Assignee: SUTENG INNOVATION TECHNOLOGY CO., LTD., Shenzhen (CN)

(21) Appl. No.: 19/403,990

(22) Filed: Nov. 30, 2025

(30) Foreign Application Priority Data
Dec. 4, 2024 (CN) 202411777386.7
Dec. 12, 2024 (CN) 202411839772.4

(51) Int. Cl. G01S 7/481

(52) U.S. Cl. CPC G01S 7/4817; G01S 7/4813

(57) ABSTRACT

A circuit board structure and a LiDAR. The structure includes a substrate, a main control circuit board, a flexible circuit board, and a first scanning module. A first end of the flexible circuit board is fixedly connected to the main control circuit board, and a second end of the flexible circuit board is located between the first scanning module and the substrate. The substrate includes a first positioning post extending in a first direction, which is embedded in a first positioning hole in the flexible board's second end. The substrate further includes a second positioning post extending in the first direction, which is embedded in a second positioning hole in the scanning module. A difference between an aperture of the first hole and an outer diameter of the first post is greater than a difference between an aperture of the second hole and an outer diameter of the second post.

### CROSS-REFERENCE TO RELATED APPLICATION

The present application claims the benefit of priority to Chinese Patent Application No. 202411839772.4, filed on Dec. 12, 2024, and No. 202411777386.7, filed on Dec. 4, 2024, which are hereby incorporated by reference in their entirety.

### TECHNICAL FIELD

The present application pertains to the field of flexible circuit board mounting, and more specifically, to a circuit board structure and a LiDAR.

### BACKGROUND

LiDAR is a high-precision detection instrument integrating components such as scanning module, emission module, receiving module, and main control circuit board. Flexible Printed Circuits (FPCs) are widely used to meet the wiring requirements of LiDARs.

Traditional flexible circuit board mounting technologies struggle to meet the increasingly stringent miniaturization requirements of LiDAR applications due to the need for sufficient insertion/removal space. To address this challenge, floating connectors are commonly employed in the prior art. Floating connectors automatically latch upon structural alignment. However, floating connectors exhibit low stability, high structural complexity, and high costs.

### SUMMARY

Embodiments of the present application provide a circuit board structure and a LiDAR, aiming to improve assembly efficiency within limited space and facilitate miniaturized LiDAR design.

In a first aspect, embodiments of the present application provide a circuit board structure including a substrate, a main control circuit board, a flexible circuit board, and a first scanning module. The main control circuit board is fixed to the substrate, a first end of the flexible circuit board is fixedly connected to the main control circuit board, and a second end of the flexible circuit board is located between the first scanning module and the substrate. The substrate includes a first positioning post extending along a first direction, and the second end of the flexible circuit board includes a first positioning hole. The first direction is a thickness direction of the substrate, and the first positioning post is embedded in the first positioning hole. The substrate further includes a second positioning post extending along the first direction, and the first scanning module includes a second positioning hole. The second positioning post is embedded in the second positioning hole. A difference between an aperture of the first positioning hole and an outer diameter of the first positioning post is greater than a difference between an aperture of the second positioning hole and an outer diameter of the second positioning post.

In some embodiments, the first scanning module includes a first rotating mirror, a rotating mirror circuit board, and a rotating mirror bracket. The rotating mirror bracket includes the second positioning hole, the rotating mirror circuit board is located between the rotating mirror bracket and the first rotating mirror, and the second end of the flexible circuit board is located between the rotating mirror bracket and the substrate.

In some embodiments, the rotating mirror bracket further includes a third positioning hole, and the substrate further includes a third positioning post extending along the first direction. The third positioning post is embedded in the third positioning hole, and the third positioning hole is an elongated hole.

The elongated hole limits adjustment to a single direction, thereby constraining the first scanning module to adjust its pose in one direction. This enables quicker precise alignment between the second positioning hole and the second positioning post, improving assembly efficiency.

In some embodiments, an aperture of the third positioning hole is greater than an outer diameter of the third positioning post.

The third positioning hole serves as a coarse positioning hole to assist rapid positioning of the fine positioning hole (second positioning hole). The cooperation between the third positioning hole and the third positioning post further restricts the relative position between the first scanning module and the substrate based on the movable embedding of the first positioning post and the first positioning hole. Meanwhile, it retains floating clearance, facilitating precise alignment between the second positioning post and the second positioning hole within a smaller pose adjustment range of the first scanning module, thereby enhancing assembly efficiency.

In some embodiments, the rotating mirror bracket further includes a first through hole, the rotating mirror circuit board includes a first connector, and the second end of the flexible circuit board further includes a second connector. The first connector passes through the first through hole and is fixedly connected to the second connector.

In some embodiments, the substrate further includes a first boss extending along the first direction, and the second positioning post is formed on the first boss and extends along the first direction; and a sum of a length of the first boss along the first direction and a length of the second positioning post along the first direction is a third length, and the third length is greater than a length of the first positioning post along the first direction.

During installation, the rotating mirror bracket contacts the second and third positioning posts first for precise positioning and embedding, preventing premature contact with the first positioning post and avoiding interference with the installation of the first scanning module.

In some embodiments, the substrate further includes a second boss extending along the first direction; the first boss abuts against a surface of the rotating mirror bracket facing the substrate, the second boss abuts against the surface of the rotating mirror bracket facing the substrate; and a length of the second boss along the first direction equals that of the first boss along the first direction.

The first boss and multiple second bosses separate the rotating mirror bracket from the substrate to accommodate the second end of the flexible circuit board. This prevents the second end from contacting the substrate or rotating mirror bracket and bearing assembly stress, ensuring successful establishment of the gap between the second end of the flexible circuit board and the substrate. Simultaneously, the first boss and multiple second bosses act as limiters for the first scanning module in the first direction to control its installation position. The distributed arrangement of the first boss and multiple second bosses also provides stable support, enhancing installation stability of the first scanning module.

In some embodiments, the substrate further includes a third boss extending along the first direction, the third boss includes a fourth positioning post extending along the first direction, the main control circuit board includes a fourth positioning hole and a third connector, and the first end of the flexible circuit board includes a fourth connector. The fourth positioning post is embedded in the fourth positioning hole, and the third connector is fixedly connected to the fourth connector.

The third boss supports and fixes the main control circuit board while separating it from the substrate to prevent excessive assembly stress or stress induced by substrate deformation.

In some embodiments, a gap along the first direction exists between the second end of the flexible circuit board and the substrate. This gap effectively prevents hard contact between the flexible circuit board and the substrate or rotating mirror circuit board, avoiding damage caused by assembly stress or external environmental impacts, thereby improving operational stability and reliability of the flexible circuit board.

In a second aspect, embodiments of the present application provide a LiDAR including a emission module, a receiving module, and the circuit board structure.

The circuit board structure and LiDAR provided herein achieve the following advantages: By presetting an adjustment margin between the first positioning hole of the second end of the flexible circuit board and the first positioning post of the substrate, preliminary positioning is achieved while reserving space for pose adjustment of the second end. During precise alignment between the first scanning module and the substrate, only minor pose adjustments to the first scanning module or the second end of the flexible circuit board are required to enable mating between the first connector on the rotating mirror circuit board and the second connector on the second end of the flexible circuit board. This reduces installation difficulty of the flexible circuit board within limited space, improves assembly efficiency of the circuit board structure, and facilitates miniaturization of the LiDAR.

### BRIEF DESCRIPTION OF DRAWINGS

FIG. 1 is a schematic structural diagram of a circuit board structure according to an embodiment of the present application;

FIG. 2 is an exploded view of a circuit board structure according to an embodiment of the present application;

FIG. 3 is a sectional view taken along line A-A of the circuit board structure in FIG. 1;

FIG. 4 is a sectional view taken along line B-B of the circuit board structure in FIG. 1;

FIG. 5 is a schematic assembly diagram of a first scanning module according to an embodiment of the present application;

FIG. 6 is a schematic assembly diagram of a first scanning module according to an embodiment of the present application;

FIG. 7 is a schematic assembly diagram of a first scanning module according to an embodiment of the present application;

FIG. 8 is a schematic structural diagram of a circuit board structure according to an embodiment of the present application;

FIG. 9 is an exploded view of a second scanning module according to an embodiment of the present application;

FIG. 10 is an exploded view of a stator assembly of a second scanning module according to an embodiment of the present application;

FIG. 11 is an exploded view of a rotor assembly of a second scanning module according to an embodiment of the present application;

FIG. 12 is a sectional view taken along line C-C of a second scanning module according to an embodiment of the present application;

FIG. 13 is a schematic structural diagram of a rotor assembly according to an embodiment of the present application;

FIG. 14 is a schematic assembly diagram of a rotor assembly and a second rotating mirror according to an embodiment of the present application;

FIG. 15 is a schematic assembly diagram of a motor and a second rotating mirror according to an embodiment of the present application;

FIG. 16 is a schematic structural diagram of a second scanning module according to an embodiment of the present application;

FIG. 17 is a top view of a second scanning module in a radial plane perpendicular to the axis of a rotating shaft according to an embodiment of the present application;

FIG. 18 is a schematic assembly diagram of a rotor assembly and a sleeve according to an embodiment of the present application;

FIG. 19 is an exploded view of a rotor assembly and a sleeve according to an embodiment of the present application;

FIG. 20 is a schematic structural diagram of an encoder disk according to an embodiment of the present application;

FIG. 21 is a schematic structural diagram of a second rotating mirror according to an embodiment of the present application;

FIG. 22 is a schematic assembly diagram of a first assembly according to an embodiment of the present application;

FIG. 23 is a schematic assembly diagram of a second assembly according to an embodiment of the present application;

FIG. 24 is a schematic assembly diagram of a third assembly according to an embodiment of the present application;

FIG. 25 is a schematic assembly diagram of a motor according to an embodiment of the present application;

FIG. 26 is a schematic assembly diagram of a second scanning module according to an embodiment of the present application; and

FIG. 27 is a schematic structural diagram of a motor according to an embodiment of the present application.

Reference Signs: 100, substrate; 110, first positioning post; 120, second positioning post; 130, first boss; 140, second boss; 150, fourth positioning post; 160, third boss; 170, third positioning post; 200, main control circuit board; 210, fourth positioning hole; 220, third connector; 300, flexible circuit board; 310, first end of flexible circuit board; 311, fourth connector; 320, second end of flexible circuit board; 321, first positioning hole; 322, second connector; 400, first scanning module; 401, second positioning hole; 402, third positioning hole; 410, first rotating mirror; 420, rotating mirror circuit board; 421, first connector; 430, rotating mirror bracket; 431, first through hole; 500, stator assembly; 510, sleeve; 511, bearing cavity; 520, iron core; 530, base; 531, support through hole; 532, fixation through hole; 533, operation opening; 540, control circuit board; 550, photoelectric detection module; 600, rotor assembly; 610, housing; 610F, first end of housing; 610S, second end of housing; 611, first mounting hole; 612, glue overflow groove; 613, first groove; 614, limiting protrusion; 620, rotating shaft; 630, tubular magnet ring; 640, encoder disk; 641, second mounting hole; 700, second rotating mirror; 700B, bottom of second rotating mirror; 700T, top of second rotating mirror; 710, limiting through hole; 720, opening; 730, mirror groove; 740, counterweight groove; 750, circular groove; 800, bearing; 800F, first bearing; 800S, second bearing; 810, bearing inner ring; 820, bearing outer ring; 830, lubrication component; 900, limiting assembly; 900F, first limiting assembly; 900S, second limiting assembly; 910, elastic support structure; 920, snap ring; 930, pressing ring; 940, shim; 1010, reflective area; 1020, non-reflective area; S1, black coating; S2, accommodation space; R1, minimum circumscribed circle of second rotating mirror; R2, radial plane projection of base; C1, first corner; C2, second corner; AS1, first assembly; AS2, second assembly; AS3, third assembly; AS4, motor; AS5, second scanning module; AS6, support mechanism.

### DETAILED DESCRIPTION

To meet the wiring requirements of LiDARs, FPCs are widely used for interconnecting electronic components within LiDARs. However, traditional FPC mounting techniques require sufficient insertion/extraction space, making them difficult to adapt to increasingly stringent requirements for LiDAR miniaturization. Particularly, to achieve connections between the scanning module mounted on the substrate and the main control circuit board, the FPC must typically be positioned in the confined space between the scanning module and the substrate to avoid interference with the rotating scanning module. This poses significant challenges for FPC positioning and installation. In the prior art, floating connectors are commonly employed to address this issue. Floating connectors automatically latch upon structural alignment. However, floating connectors exhibit low stability, complex installation and maintenance, and high costs, failing to meet the stringent requirements for LiDAR miniaturization in automotive scenarios.

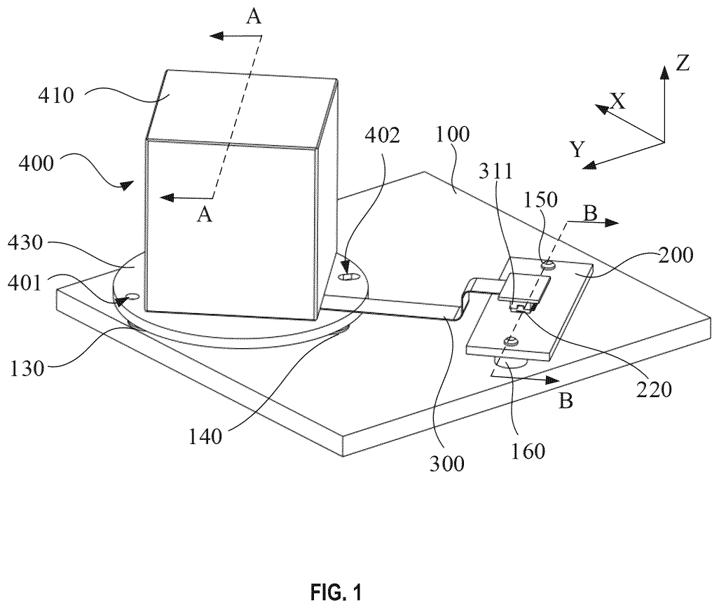

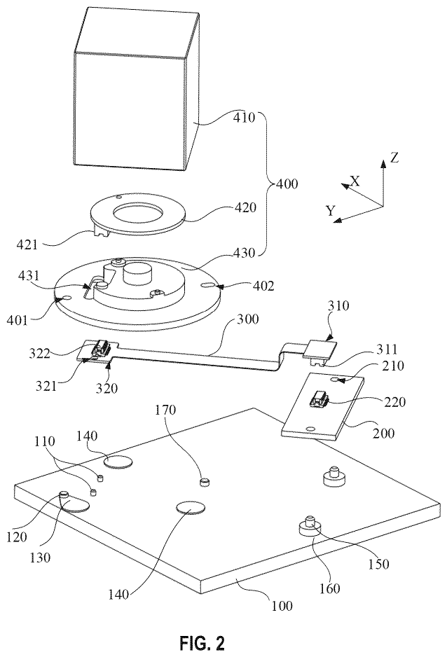

In one embodiment, referring to FIG. 1 and FIG. 2, the present application provides a circuit board structure including a substrate 100, a main control circuit board 200, a flexible circuit board 300, and a first scanning module 400. Both the main control circuit board 200 and the first scanning module 400 are fixedly mounted on the substrate 100. The substrate 100 is fixed within the LiDAR housing, or the substrate 100 forms part of the LiDAR housing. The first scanning module 400 includes a motor, a scanning element, a control circuit board corresponding to the scanning element, and a mounting bracket corresponding to the scanning element. The scanning element is a rotating mirror, galvanometer, or oscillating mirror, driven by the motor to rotate and reflect scanning beams or echo beams. The control circuit board corresponding to the scanning element is configured to, in response to control instructions from the main control circuit board 200, drive the motor and adjust its operation parameters including rotation speed, working voltage, working current, and operating duration.

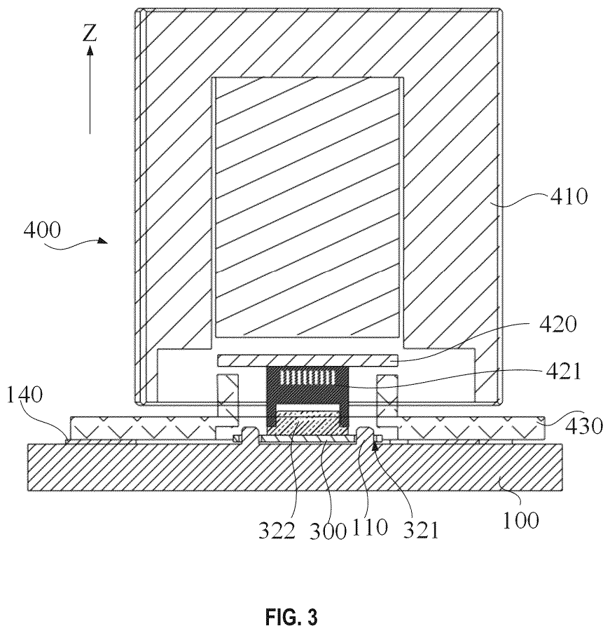

In one embodiment, referring to FIGS. 1 to 4, the scanning element is a first rotating mirror 410, and its corresponding control circuit board is a rotating mirror circuit board 420. The first scanning module 400 includes a motor, the first rotating mirror 410, the rotating mirror circuit board 420, and a rotating mirror bracket 430. Electrical connection between the rotating mirror circuit board 420 and the main control circuit board 200 is achieved via the flexible circuit board 300. A first end 310 of the flexible circuit board is fixedly connected to the main control circuit board 200, which is fixedly mounted on the substrate 100. A second end 320 of the flexible circuit board is located between the rotating mirror bracket 430 and the substrate 100.

In one embodiment, the substrate 100 includes a first positioning post 110 extending along a first direction (Z-axis direction, i.e., thickness direction of substrate 100). The second end 320 of the flexible circuit board 300 includes a first positioning hole 321. The first positioning post 110 is movably embedded in the first positioning hole 321 along the first direction to achieve preliminary positioning between the substrate 100 and the flexible circuit board 300. The substrate 100 further includes a second positioning post 120 and a third positioning post 170 extending along the first direction. The rotating mirror bracket 430 includes a second positioning hole 401 and a third positioning hole 402. The second positioning post 120 passes through the second positioning hole 401, and the third positioning post 170 passes through the third positioning hole 402 to restrict the relative position between the rotating mirror bracket 430 and the substrate 100.

In one embodiment, the rotating mirror bracket 430 is provided with a first through hole 431. The rotating mirror circuit board 420 is positioned between the rotating mirror bracket 430 and the first rotating mirror 410, making the entire first scanning module 400 more compact. The rotating mirror circuit board 420 is enclosed and protected by the rotating mirror bracket 430 and the first rotating mirror 410, reducing potential damage caused by vibration or external interference. The rotating mirror circuit board 420 includes a first connector 421, while the second end 320 of the flexible circuit board includes a second connector 322 facing the rotating mirror circuit board 420. The first connector 421 and the second connector 322 are non-floating connectors. The first connector 421 passes through the first through hole 431 along the first direction and is embedded into the second connector 322 to establish electrical connection between the rotating mirror circuit board 420 and the main control circuit board 200.

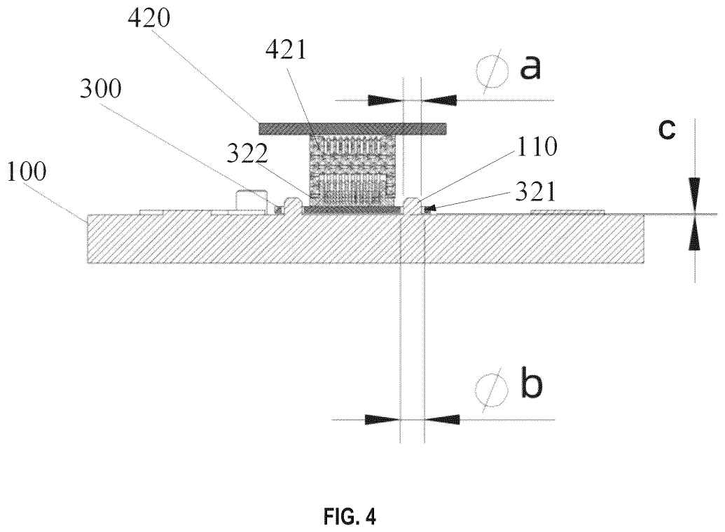

In one embodiment, referring to FIG. 4, an aperture φa of the first positioning hole 321 is greater than an outer diameter φb of the first positioning post 110, with the difference defined as a first aperture difference. An aperture of the second positioning hole 401 is slightly greater than or equal to an outer diameter of the second positioning post 120, or an interference fit exists between them (outer diameter of second positioning post 120 being slightly larger than aperture of second positioning hole 401). The difference between the aperture of the second positioning hole 401 and the outer diameter of the second positioning post 120 is defined as a second aperture difference. The first aperture difference is greater than the second aperture difference. In this circuit board structure, the first positioning hole 321 serves as a coarse positioning hole, while the second positioning hole 401 functions as a precision positioning hole. This enables movable embedding between the first positioning post 110 and the first positioning hole 321, achieving preliminary positioning of the second end 320 of the flexible circuit board 300 while reserving adjustment margin for subsequent precise positioning. Additionally, it facilitates rapid alignment between the second positioning hole 401 and the second positioning post 120.

In one embodiment, the first aperture difference relates to the installation tolerance of the first connector 421 on the rotating mirror circuit board 420. The installation tolerance refers to the tolerance within a plane perpendicular to the first direction. The first aperture difference should be larger than the installation tolerance of the first connector 421, ensuring sufficient mobility for the flexible circuit board 300 or the first scanning module 400 to achieve alignment between the first connector 421 and the second connector 322. In an embodiment, if the installation tolerance of the first connector 421 is ±0.5 mm, the first aperture difference should exceed 0.7 mm.

In one embodiment, the aperture φa of the first positioning hole 321 ranges from 120% to 300% of the outer diameter φb of the first positioning post 110. On one hand, φa≥120%*φb, which ensures movable embedding between the first positioning post 110 and the first positioning hole 321 under tolerance conditions, achieving preliminary positioning of the second end 320 of the flexible circuit board 300 on the substrate 100 and reducing assembly difficulty. On the other hand, φa≤300%*φb, which limits the relative displacement between the first positioning post 110 and the first positioning hole 321, thereby controlling the floating clearance of the second end 320 of the flexible circuit board 300. This reduces the mating difficulty between the first connector 421 and the second connector 322 during subsequent precise positioning. It facilitates rapid alignment between the second end 320 of the flexible circuit board 300 and the rotating mirror circuit board 420, as well as quick embedding between the second positioning hole 401 on the rotating mirror bracket 430 and the second positioning post 120 on the substrate 100, thereby improving assembly efficiency.

The aperture φa of the first positioning hole 321 refers to the diameter of the incircle of the projection of the first positioning hole 321 on a first plane, the first plane being perpendicular to the first direction. When the projection of the first positioning hole 321 on the first plane is circular, the diameter of this circle constitutes the aperture φa of the first positioning hole 321. When the projection of the first positioning hole 321 on the first plane is polygonal, the diameter of the incircle of this polygon constitutes the aperture φa of the first positioning hole 321. The aperture of the second positioning hole 401 refers to the diameter of the incircle of the projection of the second positioning hole 401 on the first plane. In one embodiment, both the first positioning hole 321 and the second positioning hole 401 are circular, and the aperture of each positioning hole corresponds to the diameter of its respective circle. The first positioning post 110 and the second positioning post 120 are cylindrical, with the outer diameter of each positioning post equal to the diameter of the cylinder.

In some embodiments, the shape of the first positioning hole 321 and/or the second positioning hole 401 includes one or a combination of circular, elliptical, rectangular, or rhombic, without specific limitation herein. Circular positioning holes offer excellent rotational symmetry and stability; the curved walls of a circular positioning hole can reduce stress concentration during embedding with a positioning post. They minimize the contact area between the positioning hole and the positioning post, thereby reducing interfacial stress and facilitating reduced installation stress. Rectangular positioning holes provide a larger contact area and stronger mechanical support, enhancing positional constraint through planar contact with the positioning post. The increased contact area also enables greater mechanical stress endurance. In one embodiment, the outer contour shape of the first positioning post 110 matches the aperture contour shape of the first positioning hole 321. This increases contact area for better stress distribution and enhanced positional constraint between them. Simultaneously, it facilitates control of assembly tolerances, ensuring the difference between the aperture of the first positioning hole 321 and the outer diameter of the first positioning post 110 aligns with the intended design target.

In one embodiment, referring to FIGS. 4 to 7, the assembly process of the circuit board structure is described. The components within the first scanning module 400 are adjusted as an integrated unit.

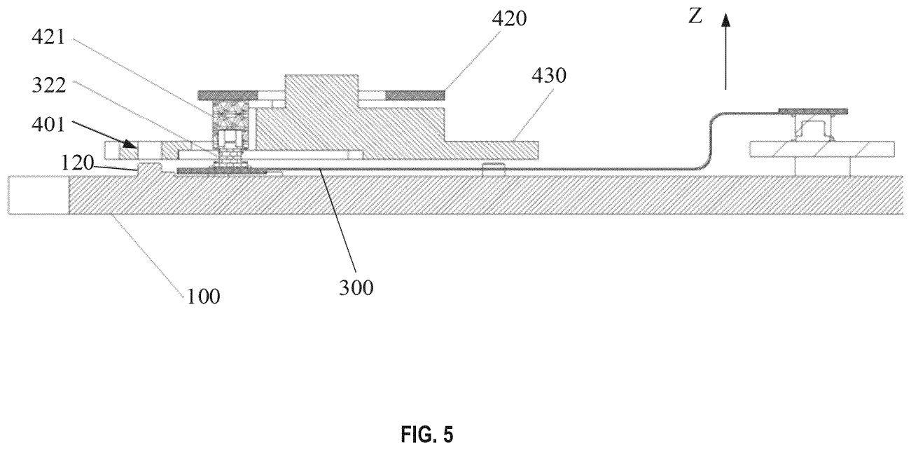

S101: Referring to FIG. 4 and FIG. 5, a fixture moves the second end 320 of the flexible circuit board to pass the first positioning post 110 through the first positioning hole 321, achieving preliminary positioning of the second end 320 of the flexible circuit board. The first end 310 of the flexible circuit board is fixed to the substrate 100.

S102: Referring to FIG. 5, after preliminary positioning of the second end 320 of the flexible circuit board 300, the fixture moves the first scanning module 400 to align the second positioning hole 401 with the second positioning post 120. Minor pose adjustments are made to either the flexible circuit board 300 or the first scanning module 400 to align the first connector 421 with the second connector 322.

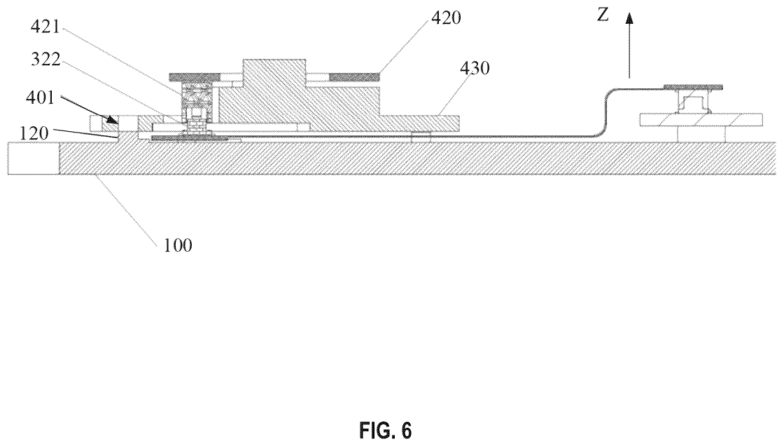

S103: Referring to FIG. 6, upon completing step S102, a constant force F along the Z-axis direction is applied via the fixture to move the first scanning module 400 slowly toward the substrate 100. The second connector 322 contacts the first connector 421 first. After the first connector 421 partially embeds into the second connector 322, the second positioning post 120 contacts the second positioning hole 401. As the first connector 421 continues to slowly embed into the second connector 322, the second positioning post 120 also slowly embeds into the second positioning hole 401.

During the assembly process of the aforementioned circuit board structure, based on the dimensional preset method where the first aperture difference is greater than the second aperture difference, the first positioning hole 321 serves as a coarse positioning hole, while the second positioning hole 401 is configured as a precision positioning hole. On one hand, utilizing the first positioning hole 321 as a coarse positioning hole enables movable embedding between the first positioning post 110 and the first positioning hole 321. This achieves preliminary positioning of the second end 320 of the flexible circuit board 300, limiting its relative displacement with respect to the substrate 100. Simultaneously, the preset first aperture difference provides adjustment margin for the subsequent precise positioning of the second end 320 of the flexible circuit board 300 in step S102. On the other hand, configuring the second positioning hole 401 as a precision positioning hole allows the second end 320 of the flexible circuit board 300 to achieve alignment of the first connector 421 and the second connector 322 with only minor pose adjustments, concurrently with the alignment of the second positioning hole 401 and the second positioning post 120. This facilitates precise positioning and fixed connection of the second end 320 of the flexible circuit board 300. Within the confined space between the rotating mirror bracket 430 and the substrate 100, this approach reduces the installation difficulty of the flexible circuit board 300, enables rapid positioning and fixed connection among the substrate 100, the first scanning module 400, and the flexible circuit board 300, and enhances the assembly efficiency of the circuit board structure and the connection stability between its components.

If the second end 320 of the flexible circuit board 300 lacks a coarse positioning hole (the first positioning hole 321) to constrain its spatial position, the position of the second end 320 would vary significantly during installation. Within the limited assembly space, efficient and rapid alignment and stable connection between the first connector 421 and the second connector 322 would be difficult to achieve. This FPC mounting method, based on the cooperation of a coarse positioning hole and a precision positioning hole, offers improved reliability, installation stability, and higher assembly efficiency compared to traditional manual assembly methods. Compared to installation methods based on floating connectors, it provides broader applicability, enhanced connection stability, simplified maintenance, and lower cost.

In one embodiment, the second end 320 of the flexible circuit board is fixedly installed between the rotating mirror bracket 430 and the substrate 100, benefiting from their enclosing protection. However, to prevent stress-induced compression on the flexible circuit board 300, as shown in FIG. 4, a gap c along the first direction is provided between the second end 320 of the flexible circuit board and the substrate 100.

In one embodiment, the preset value of gap c exceeds the installation tolerance of the first scanning module 400. For instance, if the installation tolerance of the first scanning module 400 in the first direction is 0.15 mm, gap c may be set to 0.25 mm, 0.30 mm, or 0.35 mm, ensuring that gap c is maintained between the second end 320 and the substrate 100. This prevents the rotating mirror bracket 430 from compressing the flexible circuit board 300 against the substrate 100 during assembly of the first scanning module 400 along the first direction.

In another embodiment, the preset value of gap c relates to the effective mating length of the connectors. For instance, if the effective mating length threshold of the first connector 421 and the second connector 322 is 0.6 mm, and the movable margin when the first connector 421 is installed downward along the first direction is 1 mm, then the preset value of gap c should be less than 0.4 mm, such as 0.25 mm, 0.15 mm, or 0.1 mm, ensuring the reliability of the electrical connection. The gap c effectively prevents hard contact between the flexible circuit board 300 and the substrate 100 or the rotating mirror bracket 430, avoiding damage to the flexible circuit board 300 caused by stress from installation or external environmental impacts, thereby enhancing its operational stability and reliability.

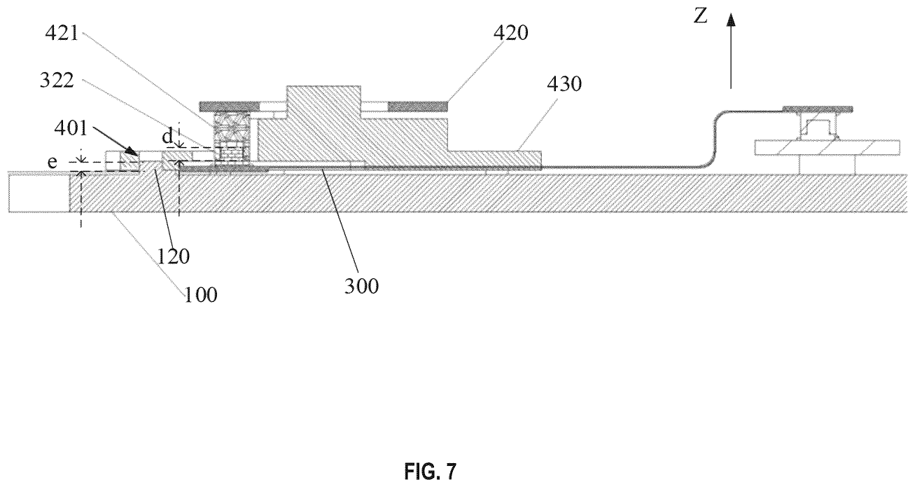

In one embodiment, after completing steps S101 to S103, referring to FIG. 7, the length along the first direction by which the first connector 421 is embedded in the second connector 322 is defined as a first length d, and the length along the first direction by which the second positioning post 120 is embedded in the second positioning hole 401 is defined as a second length e. The first length d is greater than the second length e. During the assembly of the first scanning module 400 onto the substrate 100 along the first direction, the first connector 421 contacts and begins mating with the second connector 322 at the second end 320 of the flexible circuit board first, before the second positioning post 120 and the second positioning hole 401 begin to engage. This means that during the pose adjustment of the second end 320 of the flexible circuit board, the second positioning post 120 and the second positioning hole 401 remain uncontacted, preventing the first connector 421 and the second connector 322 from bearing assembly-induced stress that could compromise connection stability. When the second positioning post 120 begins embedding into the second positioning hole 401, the first connector 421 and the second connector 322 are already partially mated, requiring no further pose adjustment. Moreover, the embedded length of the first connector 421 into the second connector 322 along the first direction gradually increases, avoiding relative misalignment that could lead to connection failure or internal stress.

In one embodiment, referring to FIG. 2, the substrate 100 further includes a first boss 130 and multiple second bosses 140 extending along the first direction. The second positioning post 120 is formed on the first boss 130 and extends along the first direction. The sum of the length of the first boss 130 along the first direction and the length of the second positioning post 120 along the first direction is a third length. This third length is greater than the length of the first positioning post 110 along the first direction and equals the length of the third positioning post 170 along the first direction. Based on this, during installation step S103, the rotating mirror bracket 430 first comes into contact with the second positioning post 120 and the third positioning post 170 for precise positioning and embedding, without initially touching the first positioning post 110, thereby preventing the first positioning post 110 from interfering with the installation of the first scanning module 400.

In one embodiment, the length of the first boss 130 along the first direction equals the length of the second boss 140 along the first direction. The first boss 130 abuts against the surface of the rotating mirror bracket 430 facing the substrate 100, and each second boss 140 abuts against the surface of the rotating mirror bracket 430 facing the substrate 100. The first boss 130 cooperates with the multiple second bosses 140 to support the rotating mirror bracket 430. The distributed arrangement of the first boss 130 and multiple second bosses 140 provides stable support, enhancing the installation stability of the first scanning module 400. The first boss 130 and multiple second bosses 140 also separate the rotating mirror bracket 430 from the substrate 100, supporting the rotating mirror bracket 430 while accommodating the second end 320 of the flexible circuit board. This prevents the second end 320 of the flexible circuit board from contacting the substrate 100 or the rotating mirror bracket 430 and bearing assembly stress, ensuring the successful establishment of gap c between the second end 320 of the flexible circuit board and the substrate 100. Simultaneously, the first boss 130 and multiple second bosses 140 act as limiters for the first scanning module 400 in the first direction, controlling its installation position along this direction.

In one embodiment, the third positioning post 170 is embedded in the third positioning hole 402. The third positioning hole 402 is a slotted hole, which restricts positional adjustment to a single direction, thereby limiting the pose adjustment of the first scanning module 400 to a single direction. This enables faster precise alignment between the second positioning hole 401 and the second positioning post 120, improving assembly efficiency.

In one embodiment, the third positioning hole 402 is a slotted hole with an aperture larger than the outer diameter of the third positioning post 170. The third positioning hole 402 serves as a coarse positioning hole to assist rapid positioning of the precision positioning hole (second positioning hole 401). The cooperation between the third positioning hole 402 and the third positioning post 170 further restricts the relative position between the first scanning module 400 and the substrate 100 beyond the movable embedding of the first positioning post 110 and the first positioning hole 321. Simultaneously, it retains a certain floating clearance, facilitating precise alignment between the second positioning post 120 and the second positioning hole 401 within a smaller adjustment range for enhanced assembly efficiency.

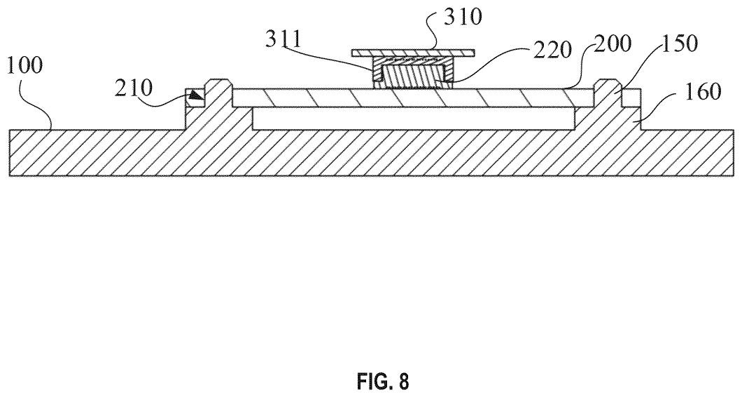

In one embodiment, referring to FIG. 2 and FIG. 8, the substrate 100 further includes a fourth positioning post 150. The main control circuit board 200 includes a fourth positioning hole 210 and a third connector 220. The first end 310 of the flexible circuit board includes a fourth connector 311. The fourth positioning post 150 is embedded in the fourth positioning hole 210 to achieve fixed installation of the main control circuit board 200 on the substrate 100. The third connector 220 is fixedly connected to the fourth connector 311, ensuring stable and reliable electrical connection between the flexible circuit board 300 and the main control circuit board 200.

In one embodiment, the fourth positioning hole 210 and the fourth positioning post 150 may have a clearance fit or an interference fit. That is, the aperture of the fourth positioning hole 210 may be slightly larger than, equal to, or slightly smaller than the outer diameter of the fourth positioning post 150, without being specifically limited herein. The third connector 220 mates with the fourth connector 311 via insertion. Alternatively, bonding, welding, snap-fit connection, or other methods may be employed for the third connector 220 and fourth connector 311, without limitation.

In one embodiment, referring to FIG. 2 and FIG. 8, the substrate 100 further includes a third boss 160 extending along the first direction. The fourth positioning post 150 is formed on the third boss 160 and extends along the first direction. The third boss 160 abuts against the surface of the main control circuit board 200 facing the substrate 100. It supports the main control circuit board 200 and separates it from the substrate 100, preventing assembly stress or stress caused by substrate deformation. The third boss 160 also limits further movement of the main control circuit board 200 toward the substrate 100, thereby restricting its position along the first direction.

In one embodiment, the rotating mirror circuit board 420 includes a second through hole. The rotating mirror bracket 430 includes a fourth boss extending along the first direction. The first rotating mirror 410 includes a mounting groove on its side facing the rotating mirror circuit board 420. The fourth boss passes through the second through hole along the first direction and embeds into the mounting groove. Adhesive fills the space between the fourth boss and the mounting groove to achieve fixed connection. The rotating mirror circuit board 420 and rotating mirror bracket 430 may be fixedly connected via welding, fasteners, adhesive bonding, snap-fit, sleeving, etc., without exhaustive elaboration.

In one embodiment, the present application provides a LiDAR including a processor, an emission module, a reception module, and circuit board structure. In one embodiment, the processor is mounted on the main control circuit board 200. It controls the emission module to project scanning beams and the reception module to receive echo beams. The processor also sends control instructions to the motor via the flexible circuit board 300. The motor drives the first rotating mirror 410 to rotate according to the instructions, reflecting scanning beams or echo beams to enable target scanning by the LiDAR.

In some embodiments, the processor may be a Field-Programmable Gate Array (FPGA), System on Chip (SoC), Central Processing Unit (CPU), Network Processor (NP), digital signal processing circuit, Micro Controller Unit (MCU), Application-Specific Integrated Circuit (ASIC), or any combination thereof for implementing relevant functions.

In the present application, the movable embedding of the first positioning post 110 and the first positioning hole 321 achieves preliminary positioning of the second end 320 of the flexible circuit board on the substrate 100. This enhances assembly efficiency and connection stability while simplifying the connection structure. The preset first aperture difference and gap c reduce stress on the second end 320 of the flexible circuit board, improving connection stability and reliability. Furthermore, the movable embedding allows reliable connection between the first connector 421 and the second connector 322 with only minor pose adjustments to the second end 320 of the flexible circuit board or the first scanning module 400 before precise embedding of the second positioning hole 401 and the second positioning post 120. This reduces FPC installation difficulty, minimizes the space required for FPC plugging, and facilitates LiDAR miniaturization.

During actual operation of the scanning module, photoelectric encoders are required for angle detection to monitor the current operating status of the rotating mirror. A typical photoelectric encoder operates as follows: Light-emitting diodes (LEDs) and photoelectric receivers are positioned on opposite sides of an encoder disk that rotates with the rotor. Light emitted from the LEDs passes through transparent apertures on the encoder disk and is received by the photoelectric receivers on the opposite side. As the encoder disk rotates with the motor, transparent apertures and opaque zones alternately interrupt the light path, generating pulse signals at the photoelectric receiver. By counting these pulses, angular displacement information can be obtained (hereinafter referred to as a transmissive photoelectric encoder). Due to the working principle of transmissive encoders, both light-emitting and light-receiving components must be installed on opposite sides of the encoder disk, necessitating sufficient axial installation space within the scanning module. Additionally, the encoder disk itself requires a relatively large structural size to ensure adequate mechanical strength. These factors collectively result in transmissive photoelectric encoders occupying substantial space, ultimately leading to a bulky scanning module that fails to meet miniaturization requirements.

Furthermore, the resolution of transmissive photoelectric encoders depends on the number of transparent apertures on the encoder disk, which is limited by the diameter of the encoder disk and manufacturing processes. For a given diameter of the encoder disk, increasing the number of apertures requires reducing the spacing between them (hereinafter referred to as pitch). However, excessively small pitch can cause signal crosstalk, compromising detection reliability. Consequently, at low motor speeds, the limited number of pulses generated per unit time due to pitch constraints directly reduces angular detection resolution, failing to meet high-precision angle detection demands.

By adopting the reflective detection principle, the functional units for emitting detection light and receiving echo light are integrated into a photoelectric detection module on a single side of the encoder disk. This eliminates the need for components on both sides, significantly reducing axial installation space and enabling a more compact detection system. Moreover, the encoder disk only requires reflective and non-reflective zones on one side, avoiding the mechanical strength issues associated with aperture fabrication in transmissive encoder disks, thus allowing for smaller diameter encoder disks. This design improves spatial efficiency, effectively reducing the overall size of the scanning module. Additionally, the reflective encoder disk can accommodate denser patterns of reflective and absorptive zones within a smaller area, yielding more detection cycles for a given size. This feature ensures more pulse signals per unit time even at low motor speeds, achieving higher angular resolution and better meeting precision control requirements.

The following describes in detail the specific implementation of the second scanning module employing the aforementioned reflective photoelectric encoder, with reference to the accompanying drawings.

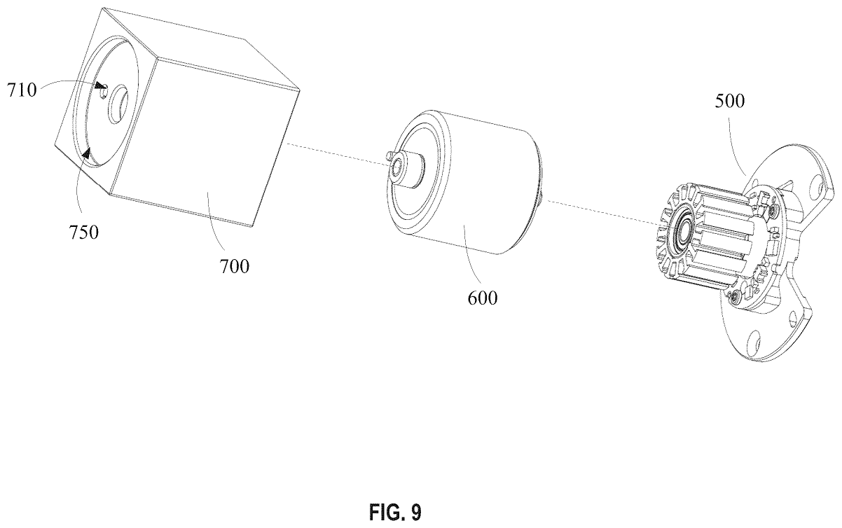

As shown in FIG. 9, the second scanning module includes: a stator assembly 500, a rotor assembly 600, and a second rotating mirror 700.

The stator assembly 500 collectively refers to components that remain stationary during operation. The rotor assembly 600 includes components that rotate relative to the stator assembly 500. The second rotating mirror 700, featuring specific reflective properties on one or more surfaces, alters the propagation direction of light beams. It is connected to and rotates with the rotor assembly 600.

The stator assembly 500 and rotor assembly 600 constitute a motor, which operates on electromagnetic induction principles to convert external electrical energy into kinetic energy driving the rotor assembly 600. The synchronized movement of the second rotating mirror 700 and rotor assembly 600 deflects incident light beams, enabling target area scanning. During scanning, the reflective photoelectric encoder inside the second scanning module detects positional changes of the encoder disk via reflected light signals, providing real-time feedback for precise motor control, thereby improving resolution and the second rotating mirror's positioning accuracy.

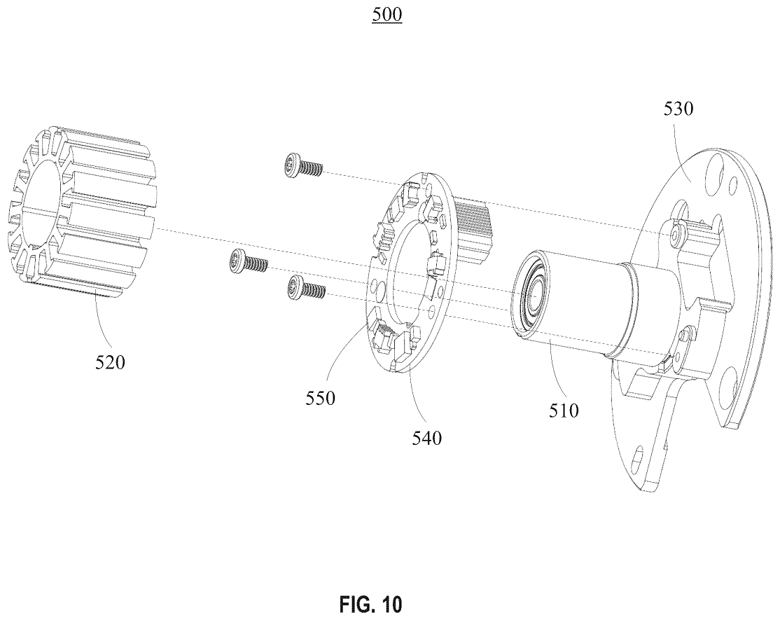

The photoelectric encoder primarily consists of an encoder disk 640 and a photoelectric detection module 550. The encoder disk 640 is mounted on the rotor assembly 600, while the photoelectric detection module 550 is installed on the stator assembly 500. The photoelectric detection module 550 includes a light-emitting element and a photodetector. The light-emitting element emits detection light, and the photodetector receives echo light reflected by the encoder disk, with both components positioned on the same side of the encoder disk 640. The detailed structure of the second scanning module is further elaborated below with reference to FIGS. 10 to 12.

In some embodiments, as shown in FIG. 10, the stator assembly 500 includes: a sleeve 510, an iron core 520, a base 530, and a control circuit board 540. The sleeve 510 is fixedly connected to both the iron core 520 and the base 530, while the control circuit board 540 is secured to the base 530.

The sleeve 510 provides rotational support for the rotor assembly. Its specific structural dimensions and shape can be configured according to practical requirements. In an embodiment, the sleeve 510 may be substantially cylindrical with specific axial length and inner diameter dimensions.

The iron core 520 establishes a closed magnetic circuit to generate the corresponding induction magnetic field. Specifically, the iron core 520 includes a core body formed by laminated silicon steel sheets and coils wound within the winding slots of the core body.

The base 530 supports the entire motor structure and provides mounting interfaces. The base 530 may employ any suitable material, size, or structure according to practical needs, provided it offers sufficient mechanical strength and stability to ensure the motor's overall rigidity meets operational requirements.

The control circuit board 540 is a printed circuit board integrating one or more functional circuits (including but not limited to drive circuits, signal processing circuits, etc.), enabling power supply, control, and signal processing functions for the second scanning module. The control circuit board 540 mounts the photoelectric detection module 550. The photoelectric detection module 550 includes a light-emitting device and a light-receiving device. The light-emitting device emits detection light of a specific wavelength, while the light-receiving device receives echo light reflected from the reflective areas on the encoder disk surface and converts it into electrical signals. Signal processing circuits on the control circuit board 540 can utilize these electrical signals from the photoelectric detection module 550 to achieve precise detection of the second scanning module's rotation angle, speed, and direction, ensuring accurate motor control.

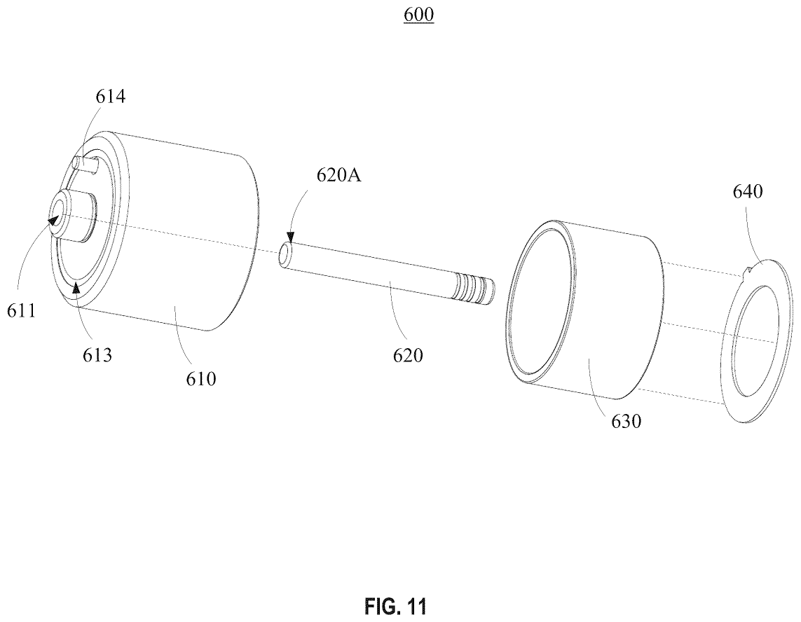

In some embodiments, as shown in FIG. 11, the rotor assembly 600 includes: a housing 610, a rotating shaft 620, a tubular magnet ring 630, and an encoder disk 640. The rotating shaft 620 is fixed to the housing 610 via an interference fit. The tubular magnet ring 630 and the encoder disk 640 are fixedly connected to the housing 610.

The housing 610 installs and secures the rotor assembly. It can have specific shapes and sizes as needed to provide overall protection for the rotor assembly and ensure component coaxiality.

The rotating shaft 620 bears radial and axial loads and transmits torque. As the motor's main shaft, it supports the rotor assembly 600 rotating around its axis. The interference fit between the rotating shaft 620 and the housing 610 prevents relative displacement during high-speed rotation. In one embodiment, this interference fit is achieved by: forming a first mounting hole 611 in the center of the housing 610, where the outer diameter of the shaft end is slightly larger than the inner diameter of the first mounting hole 611. The rotating shaft 620 is then press-fitted into the housing 610 for a reliable fixed connection.

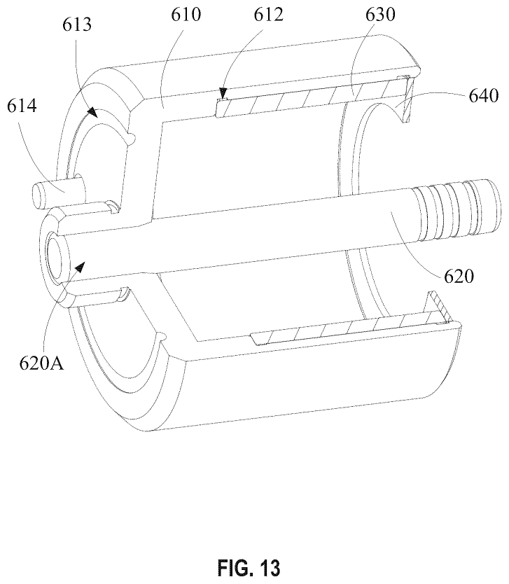

The tubular magnet ring 630 is a cylindrical permanent magnet that interacts electromagnetically with the iron core 520 within the stator assembly 500 to convert electrical energy into mechanical energy. In some embodiments, the tubular magnet ring 630 is bonded to the interior of the housing 610 using adhesive. Correspondingly, as shown in FIG. 13, the inner surface of the housing 610 features a glue overflow groove 612 to accommodate excess adhesive.

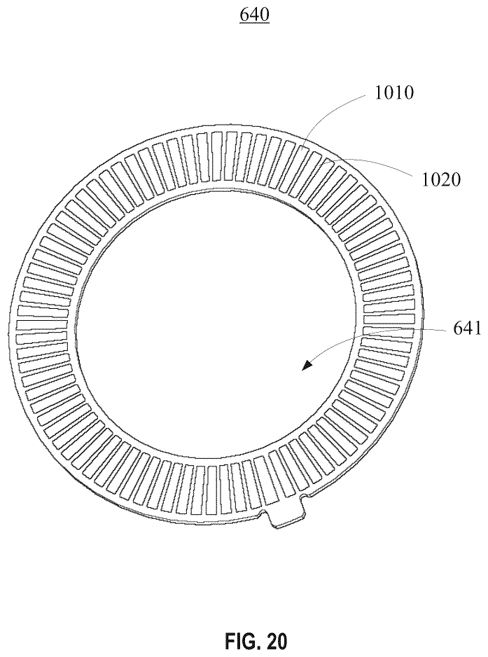

The encoder disk 640 is a disk-shaped component. Its surface features areas with distinct optical properties that cooperate with the photoelectric detection module 550 for precise angle position detection. Areas on the encoder disk 640 capable of reflecting detection light to form echo light are reflective areas 1010, while areas that cannot form echo light are non-reflective areas 1020. Multiple reflective areas 1010 and non-reflective areas 1020 are alternately arranged on the encoder disk 640. These alternating areas are distributed circumferentially around the encoder disk 640 at specific intervals. As shown in FIG. 20, in the circumferential direction, adjacent reflective areas 1010 are separated by a non-reflective area 1020, and adjacent non-reflective areas 1020 are separated by a reflective area 1010, forming a regular periodic pattern. This alternating arrangement enables the photoelectric detection module 550 to generate stable pulse signals as the encoder disk 640 rotates, thereby accurately detecting the angular displacement of the rotor assembly.

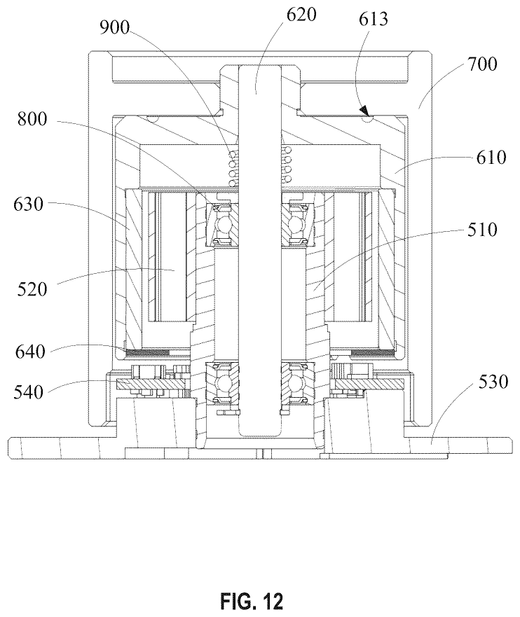

FIG. 12 is a cross-sectional view of the second scanning module, illustrating the assembly relationship between the stator assembly 500 and the rotor assembly 600. As shown, within the second scanning module, the rotating shaft 620 is centrally positioned along the axis of the sleeve 510. The iron core 520 is situated inside the tubular magnet ring 630.

During operation of the second scanning module, when current is applied to the coils within the iron core 520, it generates an electromagnetic field. This field interacts with the permanent magnetic field of the tubular magnet ring 630, producing tangential electromagnetic forces that generate driving torque on the tubular magnet ring 630. Under this driving torque, the rotor assembly 600 rotates around the axis of the sleeve 510. Simultaneously, the rotation of the rotor assembly 600 drives the encoder disk 640 to rotate synchronously. When a reflective area 1010 on the encoder disk 640 passes the photoelectric detection module 550, detection light emitted by the photoelectric detection module 550 is reflected to form echo light. When a non-reflective area 1020 passes, the detection light is absorbed. This alternating reflection and absorption creates periodic electrical signal pulses. By counting and processing these pulses, signal processing circuits integrated on the control circuit board 540 can determine the precise angular position of the rotor assembly 600 in real time, enabling precise control of the second scanning module.

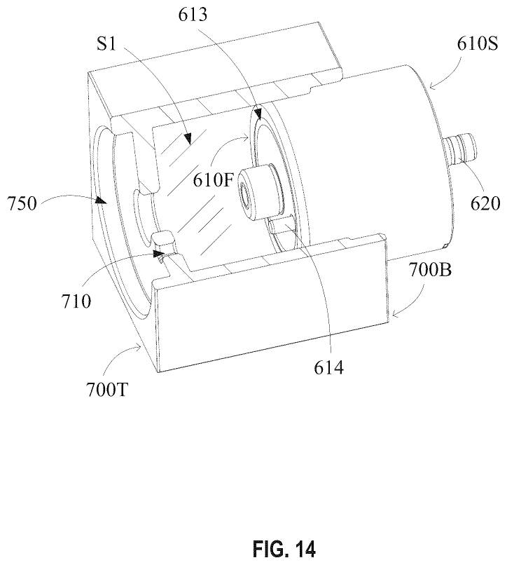

The connection between the second rotating mirror 700 and the rotor assembly 600 is described in detail below with reference to FIGS. 13 and 14.

As shown in FIG. 14, the second rotating mirror 700 encloses the housing 610 of the rotor assembly 600 and rotates synchronously with it.

The end of the housing 610 distal to the base 530 is termed the “first end 610F of the housing”. The end of the housing 610 proximal to the base 530 is termed the “second end 610S of the housing”. The end of the second rotating mirror 700 proximal to the base 530 is termed the “bottom 700B of the second rotating mirror”. The end of the second rotating mirror 700 distal to the base 530 is termed the “top 700T of the second rotating mirror”.

In some embodiments, the top 700T of the second rotating mirror may be bonded via adhesive to a part or the whole outer surface of the first end 610F of the housing 610. Correspondingly, as shown in FIG. 13, the outer surface of the first end 610F features a first groove 613 to accommodate excess adhesive.

In some embodiments, to ensure synchronous rotation between the second rotating mirror 700 and the housing 610, additional locating pins or similar pin structures can be added. As shown in FIG. 14, the first end 610F of the housing is provided with a limiting protrusion 614. The top 700T of the second rotating mirror is provided with a corresponding limiting through hole 710. When the second rotating mirror 700 encloses the housing 610 of the rotor assembly 600, the limiting protrusion 614 extends through the limiting through hole 710, achieving circumferential positioning between the second rotating mirror 700 and the housing 610. This ensures the second rotating mirror 700 cannot rotate relative to the housing 610.

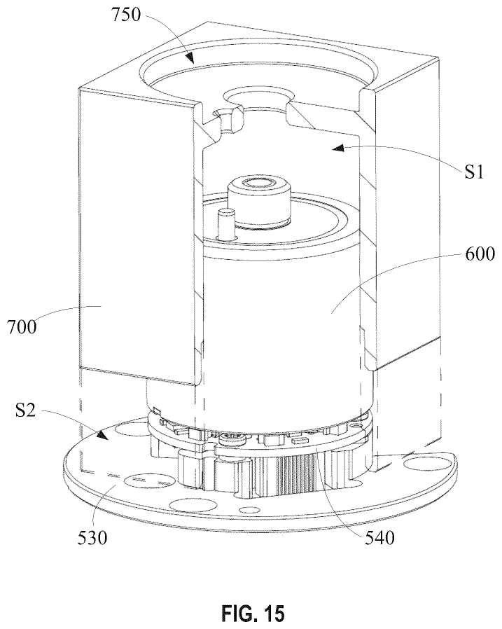

The following describes in detail multiple embodiments provided in the present application for reducing interference from external environments and stray light, with reference to FIGS. 15 to 21.

In some embodiments, as shown in FIG. 15, the inner surface of the second rotating mirror 700 is coated with a black coating S1. Both the rotor assembly 600 and the control circuit board 540 are located within an accommodation space S2 enclosed by the second rotating mirror 700 and the base 530. Interference or stray light from the external environment is absorbed by the black coating on the inner surface of the second rotating mirror 700, preventing further reflection onto the control circuit board 540. This reduces interference with the photoelectric detection module 550 and avoids generating erroneous position detection signals.

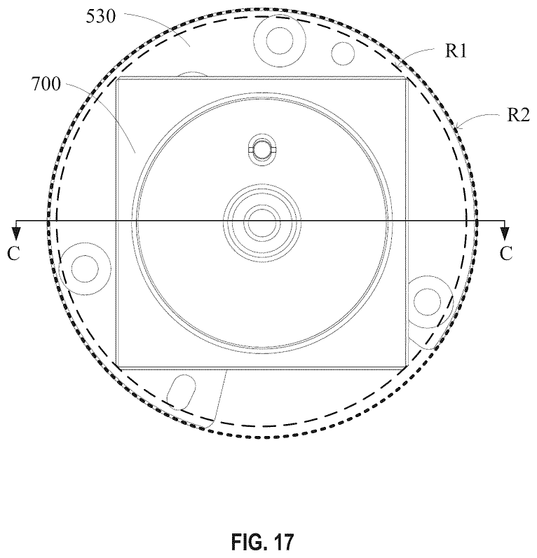

In some embodiments, as shown in FIG. 17, the minimum circumscribed circle of the second rotating mirror 700 is covered by the radial plane projection of the base 530. Here, the minimum circumscribed circle of the second rotating mirror 700 refers to the circumscribed circle R1 of the projection of the second rotating mirror 700 along the axial direction of the rotating shaft 620 onto a radial plane perpendicular to the axis. The radial plane projection of the base 530 refers to the projection R2 formed by the base 530 along the same axis onto the radial plane. The base 530 covers the area swept by the second rotating mirror 700 during rotation, further attenuating stray light interference from the external environment on the photoelectric detection module 550.

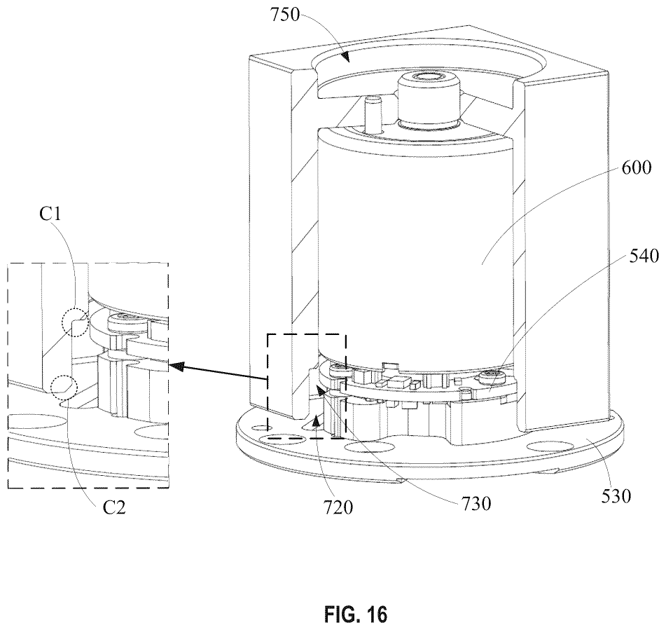

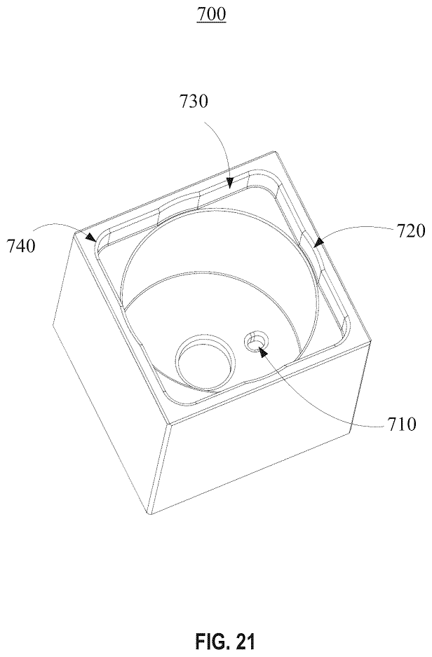

In some embodiments, as shown in FIG. 21, an opening 720 is provided at the bottom 700B of the second rotating mirror 700. A mirror groove 730 is formed along the circumference of the opening 720 on the inner surface of the second rotating mirror. The edge of the control circuit board 540 is accommodated within the space formed by the mirror groove 730. As shown in FIG. 16, a first corner C1 is formed between the control circuit board 540 and the mirror groove 730, while a second corner C2 is formed between the bottom 700B of the second rotating mirror 700 and the base 530. Stray light or other interfering light from the external environment experiences significant energy attenuation after passing through the first corner C1 and second corner C2. This weakens external light entering the photoelectric detection module 550, effectively reducing interference through this structural arrangement.

The shape of the second rotating mirror 700 used in the second scanning module can be selected based on practical requirements. The drawings in the present application show a second rotating mirror 700 shaped as a regular quadrilateral prism. In some embodiments, other regular polygonal prisms may be used, such as a second rotating mirror in the form of a regular triangular prism.

In some embodiments, as shown in FIG. 21, when using a second rotating mirror 700 shaped as a regular polygonal prism, a counterweight groove 740 is provided at each vertex corner of the bottom 700B to accommodate counterweight material.

Due to factors like machining tolerances and material density variations, the mass distribution of the second rotating mirror 700 inevitably becomes uneven, causing the center of gravity to deviate from the rotational axis. This eccentricity generates unnecessary centrifugal forces during high-speed rotation, affecting stable operation. To maximize operational stability, filling specific counterweight grooves 740 with counterweight material creates a compensating torque on the circumference of the second rotating mirror 700. This torque, equal in magnitude but opposite in direction to the original eccentric mass, aligns the center of gravity with the geometric center (or positions it on the rotational axis). This ensures stable high-speed rotation. Furthermore, this structural design completely encapsulates the counterweight material within the counterweight grooves 740 at the bottom vertices, avoiding impact on the optical working surfaces of the second rotating mirror.

In some embodiments, as shown in FIG. 14, a circular groove 750 is provided at the top 700T of the second rotating mirror to accommodate counterweight material. The center of the circular groove 750 lies on the axis of the rotating shaft 620. This circular groove 750 serves as a reserved location for dynamic balance calibration. By controlling the weight and position of the counterweight material, it assists in achieving dynamic balance during rotation, reducing vibration and eccentricity at high speeds. For instance, adding mass at any point on a circumference offers a simple and direct calibration process.

In other embodiments, vertex grooves are provided at each corner of the top 700T of the second rotating mirror to accommodate counterweight material. This facilitates subsequent motor calibration and improves dynamic balance calibration efficiency.

The second scanning module can incorporate one or more additional auxiliary structures. These serve functions such as providing necessary support for the rotating shaft 620, reducing friction between the rotating shaft 620 and the sleeve 510, and suppressing radial runout or axial displacement that may occur during high-speed rotation. This ensures more stable, precise, and reliable rotational motion of the rotor assembly.

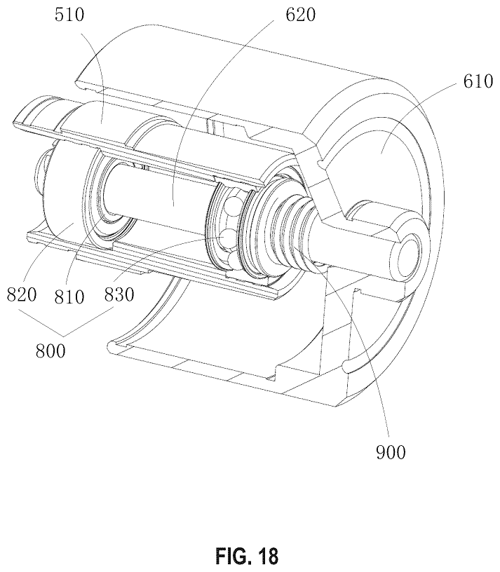

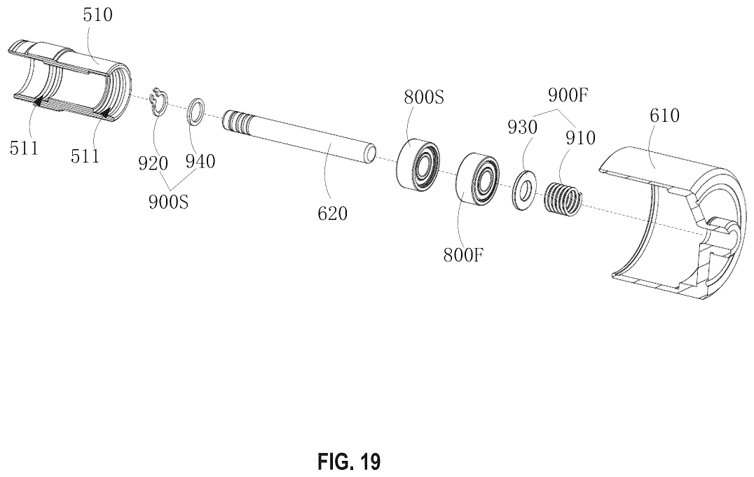

The following describes in detail various embodiments of auxiliary structures provided in the present application, with reference to FIG. 18 and FIG. 19, to fully illustrate their structural features and operational principles.

As shown in FIG. 18, the second scanning module further includes bearings 800 and a limiting assembly 900.

The bearings 800 are assembled between the rotating shaft 620 and the sleeve 510 to bear radial loads and enable low-friction relative rotation between them.

The limiting assembly 900 controls the axial position of the bearings 800. It interfaces with the bearings 800 and applies an appropriate axial preload to eliminate internal bearing clearance, thereby enhancing radial stiffness and rotational accuracy.

As shown in FIG. 19, the sleeve 510 internally defines a bearing cavity 511 to accommodate the bearings 800. As shown in FIG. 18, each bearing 800 includes: a bearing inner ring 810, a bearing outer ring 820, and a lubrication component 830. The bearing inner ring 810 has an interference fit with the rotating shaft 620, while the bearing outer ring 820 has a clearance fit with the bearing cavity 511. This combination ensures bearing positioning accuracy while facilitating assembly and replacement.

In some embodiments, the bearing outer ring 820 is bonded to the bearing cavity 511. In other embodiments, considering factors like assembly difficulty, maintenance convenience, and operational reliability, alternative fixing methods such as snap rings or end cap compression may be used.

In some embodiments, the lubrication component 830 is located between the bearing inner ring 810 and bearing outer ring 820 to reduce friction. Specifically, it includes, but is not limited to: rolling elements, a cage, or lubricating oil.

FIG. 18 shows two bearings 800. However, one skilled in the art will understand that the number can be increased or decreased as needed, not limited to two. The two bearings 800 are termed the “first bearing 800F” and “second bearing 800S”. Correspondingly, the limiting assemblies restricting axial movement of each are termed the “first limiting assembly 900F” and “second limiting assembly 900S”.

Using the first bearing 800F and second bearing 800S as examples, the connection to their limiting assemblies and the design rationale are detailed below with reference to FIG. 19. Here, the “upper end face” refers to the face distal to the base, and the “lower end face” refers to the face proximal to the base.

In some embodiments, as shown in FIG. 19, the first limiting assembly 900F includes: an elastic support structure 910 and a pressing ring 930. The elastic support structure 910 is sleeved onto the rotating shaft 620. Its ends abut the first end 610F of the housing and the pressing ring 930 respectively. The pressing ring 930 is also sleeved onto the rotating shaft 620 and abuts the end face of the first bearing 800F proximal to the first end 610F of the housing.

This design allows the elastic support structure 910 to indirectly press against the bearing inner ring 810 of the first bearing 800F via the pressing ring 930. It continuously applies axial preload, automatically compensating for bearing clearance through elastic deformation, while the pressing ring 930 provides stable axial positioning. Together, they achieve reliable preloading and limiting of the bearing.

In other embodiments, as shown in FIG. 19, the second limiting assembly 900S includes: a snap ring 920 and a shim 940. The bearing inner ring 810 of the second bearing 800S is fixedly connected to the rotating shaft 620. The snap ring 920 is sleeved onto the rotating shaft 620. The upper end face of the shim 940 abuts the lower end face of the second bearing 800S. The lower end face of the shim 940 abuts the upper end face of the snap ring 920. This rigid contact path achieves axial limitation of the second bearing 800S. This second limiting assembly 900S features simple structure, easy assembly, and stable axial positioning.

The first limiting assembly 900F and second limiting assembly 900S respectively demonstrate a preload-based method using an elastic support structure and a rigid limiting method using a snap ring. These methods can be chosen based on specific application requirements (e.g., assembly space, preload needs, assembly convenience) and are not limited to the scenarios described herein.

During assembly of the second scanning module, the stator assembly 500 and rotor assembly 600 are typically assembled separately before the rotor assembly 600 is assembled onto the stator assembly 500. In this approach, since the stator assembly 500 must be inserted entirely from the bottom of the rotor assembly 600, the inner diameter of the second mounting hole in the center of the encoder disk 640, located at the rotor's bottom, must be larger than the outer diameter of the iron core 520 in the stator assembly 500; otherwise, assembly is impossible. This structural constraint forces the second mounting hole 641 of the encoder disk 640 to have a larger inner diameter, consequently impacting the overall size of both the encoder disk 640 and the motor.

During research for the present application, the inventor discovered that by designing the sleeve 510 and base 530 as two separable components, the assembly sequence can be altered:
First, the encoder disk 640 can be passed over the sleeve 510 and fixed to the tubular magnet ring 630 within the rotor assembly 600. Then, the base 530 (along with the stator assembly fixed to it) can be assembled onto the sleeve 510. In this way, the second mounting hole 641 of the encoder disk 640 no longer needs to accommodate the outer dimensions of the iron core 520; it only needs to allow the sleeve 510 to pass through smoothly. This facilitates the overall miniaturization of the second scanning module.

To fully describe the inventive concept and demonstrate the specific advantages and principles of the separable sleeve 510 and base 530, the encoder disk and its second scanning module using this structure are detailed below with reference to FIGS. 20 to 25.

As shown in FIG. 20, the encoder disk 640 is an annular component with a central circular second mounting hole 641.

The minimum allowable size for this second mounting hole 641 can be set as follows: The projection of the second mounting hole 641 onto a horizontal plane along the shaft axis must cover the projection of the sleeve 510 along the same axis, ensuring the sleeve 510 can pass through smoothly. The maximum allowable size for this second mounting hole 641 can be set as follows: The diameter of the second mounting hole 641 is smaller than the inner diameter of the tubular magnet ring 630, thereby achieving a reduction in motor size. The smaller the diameter of this circular second mounting hole 641, the greater the size reduction effect.

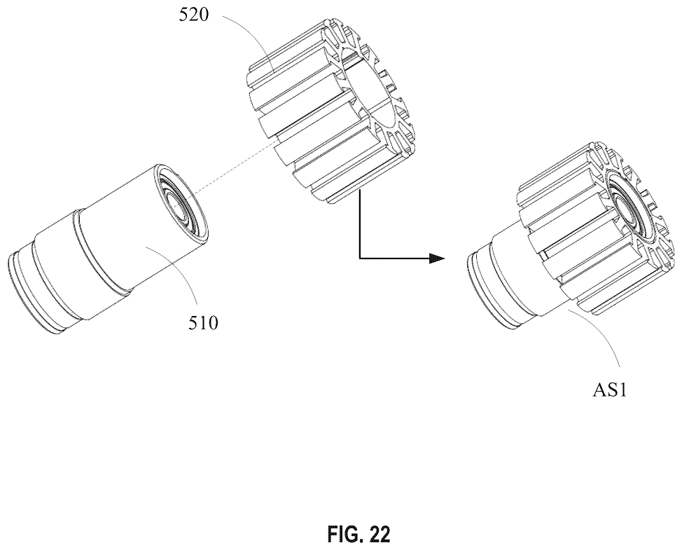

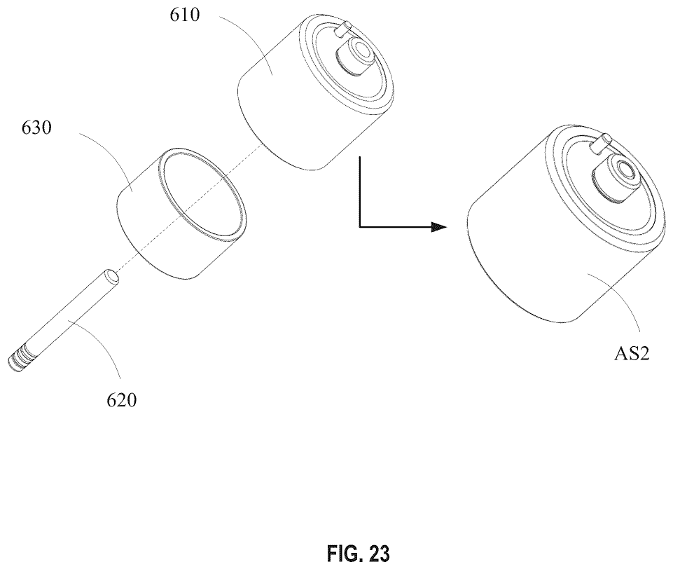

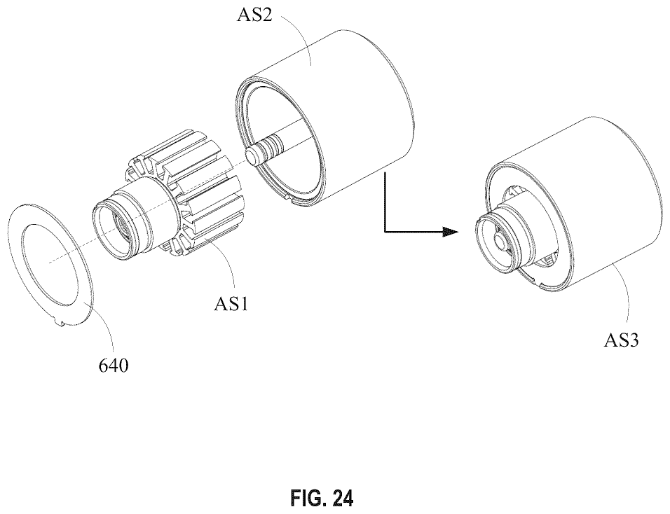

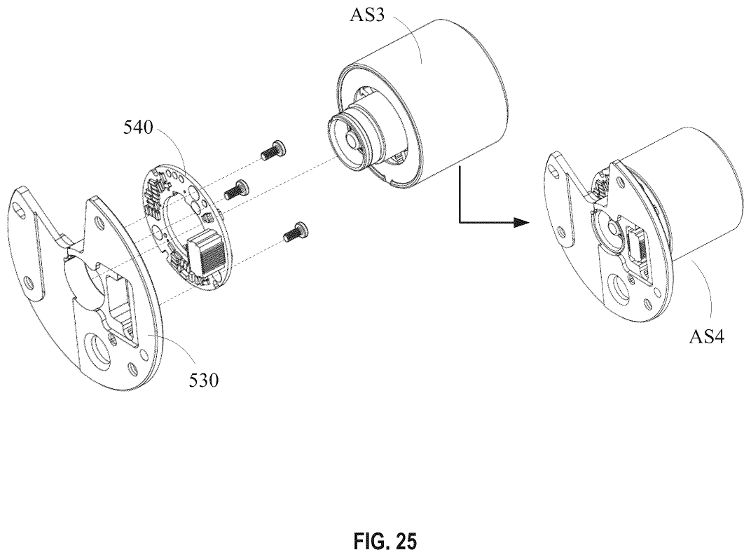

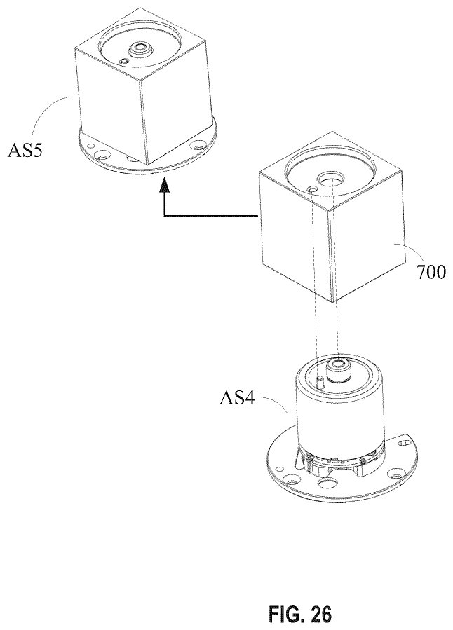

During motor assembly, as shown in FIG. 22, first, assemble and fix the iron core 520 to the sleeve 510, forming the first assembly AS1. As shown in FIG. 23, assemble and fix the rotating shaft 620 and tubular magnet ring 630 to the housing 610, forming the second assembly AS2. Next, as shown in FIG. 24, align and insert the rotating shaft 620 into the sleeve 510, assembling the first assembly AS1 into the second assembly AS2 (at this point, the iron core 520 is surrounded by the tubular magnet ring 630). Subsequently, pass the encoder disk 640 over the sleeve 510 and assemble/fix it to the tubular magnet ring 630, forming the third assembly AS3. Finally, as shown in FIG. 25, secure the control circuit board 540 to the base 530 using screws or similar fasteners, and then assemble/fix the base 530 to the sleeve 510, obtaining the complete motor AS4. It should be noted that this assembly sequence is exemplary and does not limit the specific motor components or their assembly order. As long as the third assembly AS3 is formed after the second assembly AS2 (i.e., the encoder disk 640 is fixed to the tubular magnet ring 630 after the iron core 520 is surrounded by it), the effect of reducing the minimum size constraint for the second mounting hole 641 is achieved. After assembling the motor AS4, as shown in FIG. 26, the second rotating mirror 700 is further enclosed and fixed onto the housing 610 to obtain the final second scanning module AS5.

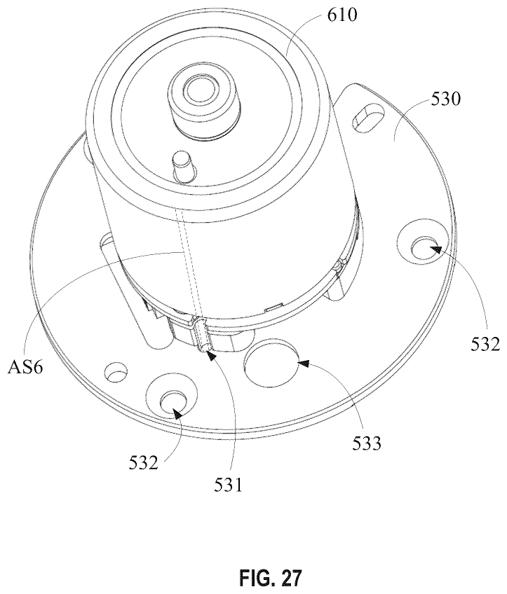

In some embodiments, as shown in FIG. 27, the base 530 is provided with one or more support through holes 531.

Applying sufficient pressing force during assembly of the second rotating mirror 700 can reduce its installation tilt angle. However, excessive force can cause wear on the bearings between the stator assembly 500 and rotor assembly 600. To minimize this negative impact while allowing strong pressing force, a removable support mechanism AS6 (e.g., a support rod or similar rod-like object) can be inserted through the support through holes 531 during assembly of the second rotating mirror 700. This mechanism abuts the housing 610, providing counteracting support force. Thus, most of the pressing force applied to the second rotating mirror 700 is transferred to the support mechanism AS6, rather than being directly applied on the bearings 800 between the stator and rotor assemblies. This effectively avoids negative effects caused by excessive pressing force, allowing the confident use of stronger force during assembly.

To verify the reliability of the second scanning module, an optical performance simulation experiment was conducted on the photoelectric detection module 550. Under simulated solar radiation conditions using an ideal parallel light source with 1 W emission power, the photoelectric detection module 550 stably received optical signals during normal operation. The received energies were 2.46×10⁻¹² W and 1.76×10⁻¹¹ W for the two modules. The noise level of the photoelectric detection module was below 1×10⁻⁶ W, and the received signal strength was significantly lower than the noise threshold (approximately 5-6 orders of magnitude difference), indicating ample Signal-to-Noise Ratio (SNR) margin. This demonstrates excellent anti-interference capability and signal detection reliability, confirming that the second scanning module can provide stable and reliable position feedback signals in real-world environments.

Based on the second scanning module described above, the present application further provides a LiDAR. As shown in FIG. 27, the base 530 of this second scanning module can include several fixation through holes 532 and an operation opening 533. Screws or similar fasteners passing through the fixation through holes 532 secure the second scanning module inside the LiDAR. The operation opening 533 allows for welding power supply wires to the iron core 520 and performing dynamic balance calibration, ensuring reliable and smooth operation of the second scanning module.

What is claimed is:

1. A circuit board structure, comprising a substrate, a main control circuit board, a flexible circuit board, and a first scanning module,
wherein the main control circuit board is fixed to the substrate, a first end of the flexible circuit board is fixedly connected to the main control circuit board, and a second end of the flexible circuit board is located between the first scanning module and the substrate;
wherein the substrate comprises a first positioning post extending along a first direction, and the second end of the flexible circuit board comprises a first positioning hole, wherein the first direction is a thickness direction of the substrate, and the first positioning post is embedded in the first positioning hole;
wherein the substrate further comprises a second positioning post extending along the first direction, and the first scanning module comprises a second positioning hole; and
wherein the second positioning post is embedded in the second positioning hole, and a difference between an aperture of the first positioning hole and an outer diameter of the first positioning post is greater than a difference between an aperture of the second positioning hole and an outer diameter of the second positioning post.

2. The circuit board structure according to claim 1, wherein the first scanning module comprises a first rotating mirror, a rotating mirror circuit board, and a rotating mirror bracket; and
wherein the rotating mirror bracket comprises the second positioning hole, the rotating mirror circuit board is located between the rotating mirror bracket and the first rotating mirror, and the second end of the flexible circuit board is located between the rotating mirror bracket and the substrate.

3. The circuit board structure according to claim 2, wherein the rotating mirror bracket further comprises a third positioning hole, and the substrate further comprises a third positioning post extending along the first direction; and
wherein the third positioning post is embedded in the third positioning hole, and the third positioning hole is an elongated hole.

4. The circuit board structure according to claim 3, wherein an aperture of the third positioning hole is greater than an outer diameter of the third positioning post.

5. The circuit board structure according to claim 2, wherein the rotating mirror bracket further comprises a first through hole, the rotating mirror circuit board comprises a first connector, and the second end of the flexible circuit board further comprises a second connector; and
wherein the first connector passes through the first through hole and is fixedly connected to the second connector.

6. The circuit board structure according to claim 2, wherein the substrate further comprises a first boss extending along the first direction, and the second positioning post is formed on the first boss and extends along the first direction; and
wherein a sum of a length of the first boss along the first direction and a length of the second positioning post along the first direction is a third length, and the third length is greater than a length of the first positioning post along the first direction.

7. The circuit board structure according to claim 6, wherein the substrate further comprises a second boss extending along the first direction;
wherein the first boss abuts against a surface of the rotating mirror bracket facing the substrate, the second boss abuts against the surface of the rotating mirror bracket facing the substrate; and
wherein a length of the second boss along the first direction is equal to a length of the first boss along the first direction.

8. The circuit board structure according to claim 1, wherein the substrate further comprises a third boss extending along the first direction, the third boss comprises a fourth positioning post extending along the first direction, the main control circuit board comprises a fourth positioning hole and a third connector, and the first end of the flexible circuit board comprises a fourth connector; and
wherein the fourth positioning post is embedded in the fourth positioning hole, and the third connector is fixedly connected to the fourth connector.

9. The circuit board structure according to claim 1, wherein a gap along the first direction exists between the second end of the flexible circuit board and the substrate.

10. A LiDAR, comprising an emission module, a receiving module, and the circuit board structure according to claim 1.
